(19) United States
(12) Patent Application Publication
(10) Pub. No.: US 2005/0122481 A1
(43) Pub. Date: Jun. 9, 2005

(54) Projection-type image display apparatus

(76) Inventors: Futoshi Yamasaki, Yokohama (JP); Masahiko Yatsu, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/964,685

(22) Filed: Oct. 15, 2004

(30) Foreign Application Priority Data
Nov. 21, 2003 (JP) 2003-391622

(51) Int. Cl. G03B 21/00

(52) U.S. Cl. 353/31

(57) ABSTRACT

An object of the present invention is to provide a projection-type image display apparatus improved in contrast. In order to achieve the above object, the present invention includes multiple LED elements, a controller for conducting control so that part of the multiple LED elements emit light, an image display element for forming a desired optical image from the light emitted from part of the LED elements, and a projector for projecting the optical image formed by the image display element.

### CLAIM OF PRIORITY

The present application claims priority from Japanese application serial no. P2003-391622, filed on Nov. 21, 2003, the content of which is hereby incorporated by reference into this application.

### BACKGROUND OF THE INVENTION

The present invention relates to a projection-type image display apparatus that uses image display elements such as transmissive liquid crystals, reflective liquid crystals, or digital micromirror devices (DMDs).

One of known types of projection-type image display apparatus is a liquid-crystal projector for irradiating light from a light source onto an image display element such as a liquid-crystal panel, and thus providing an enlarged projection of the image displayed on the liquid-crystal panel. Recently, various types of projection-type image display apparatus with emphasis placed on contrast performance at the sacrifice of brightness are also commercially available as the home-use projection-type image display apparatus intended mainly for video display.

Specific examples aimed at enhancing contrast while at the same time minimizing a decrease in brightness include a projection-type image display apparatus which, as disclosed in Japanese Patent Laid-Open No. Hei 6-342158, converts the light beams entering from a reflector at a large angle of incidence, into parallel beams of light by use of a lens having a concave, conical surface.

Additionally, in Japanese Patent Laid-Open No. Hei 3-111806, integrator optics using two lens arrays is disclosed as means for improving a screen in the nonuniformity of luminance.

### SUMMARY OF THE INVENTION

However, for the technology disclosed in Japanese Patent Laid-Open No. Hei 6-342158, since a lens thick-walled in the direction of an optical axis and having a diameter almost equal to that of the aperture in a reflector is necessary, the corresponding projection-type image display apparatus dimensionally increases and the realization of high contrast has its limits.

A projection-type image display apparatus having a variable stop in its optics is also commercialized. In the environment where brightness is required, the luminous fluxes that a light source has are utilized to their maximum by opening the above-mentioned variable stop to obtain a projected bright image. In the environment where high contrast is required, after the variable stop is diaphragmed, luminous fluxes from the light source are intercepted only at its peripheral sections and only the flux in the vicinity of the center of the light source is utilized. This reduces the angle of incidence of the fluxes focusing on an image display element or reduces the internal surface reflection and other events of optics that deteriorate contrast. Thus, although brightness is reduced, high contrast is realized.

Providing such a variable stop, however, makes the apparatus structurally complex, as with the foregoing conventional technology, and causes the problems of an increase in price and an increase in weight. In addition, when the variable stop is diaphragmed to intercept fluxes, the intercepted fluxes generate heat, and a cooling mechanism for solving this problem becomes necessary, which in turn causes structural complexity of the projection-type image display apparatus and increases the dimensions and price thereof.

The nonuniformity of the apparatus in terms of luminance and color also arises as a further problem. The nonuniformity of luminance is an event in which the luminance within the display region of the screen for displaying the image projected by the projection-type image display apparatus varies from section to section. During RGB tri-color projection through independent optical paths, since the color introduced through a relay lens overlaps other colors by being reversed on the projection screen, the nonuniformity of luminance does not take the same state and this increases the luminance of, for example, blue or green in the screen region, thus causing the nonuniformity of color. In order to solve this problem, adjustments are performed so that the nonuniformity of color on the screen is reduced by activating the driver of the image display element and correcting the nonuniform luminance of each of the RGB display elements. These adjustments, however, pose the problem that at a grayscale level close to maximum luminance, greater amounts of adjustment correspondingly sacrifice the grayscale characteristics of the image display element.

The present invention was made in view of the above situations, and a first object of the invention is to provide a projection-type image display apparatus improved in terms of contrast.

A second object of the present invention is to provide a projection-type image display apparatus capable of correcting the nonuniformity of luminance or of color.

An image display element (for example, a liquid-crystal panel) allows high-contrast characteristics to be obtained when substantially parallel fluxes of light enter. However, when there is an increase the angle of incidence of the fluxes on the liquid-crystal panel serving as an image display element (hereinafter, this angle is referred to as the luminous flux incident angle), the incident-angle dependence of the liquid-crystal panel causes the image projected to tend to decrease in terms of contrast. FIG. 5 shows an example of changes in contrast with respect to the luminous flux incident angle of a transmissive liquid-crystal panel. It can be seen from the figure that contrast improves with increases in the luminous flux incident angle. It is desirable, therefore, that the luminous flux incident angle to the image display element be reduced to enhance contrast. Reducing the luminous flux incident angle, however, causes the problem that conversely to the above, utilization efficiency of the light decreases and the screen becomes dark. To realize enhancement of luminance and that of contrast at the same time in a projection-type image display apparatus, therefore, the luminous flux incident angle to its image display element needs to be reduced without deteriorating utilization efficiency of light.

In order to achieve the above object, the present invention takes the composition set forth in “What is claimed is:”. For example, in one aspect of the present invention, a plurality of LED elements or other small light sources are arranged with a spread, and each is constructed so as to allow independent adjustment of a light-emission state at peripheral sections and in the vicinity of a central section. In another aspect of the present invention, when only a light source disposed in the vicinity of a central section is used, a light-emission pattern produced by a plurality of light sources is formed into an appropriate shape according to particular view-angle characteristics of an image display element. In yet another aspect of the present invention, a plurality of LED elements or other small light sources are arranged with a spread and are constructed so that the light sources can be independently adjusted, one at a time or more than one at a time, in luminous intensity. Thus, in any one of the above three aspects of the present invention, the nonuniformity of color or the nonuniformity of luminance is compensated for by adjustment.

More specifically, in order to achieve the above first object, the present invention includes, for example, a plurality of LED elements, a controller for conducting control so that part of the plural LED elements emit light, an image display element for forming a desired optical image from the light emitted from the LED elements, and a projector for projecting the optical image formed by the image display element.

Furthermore, in order to achieve the above second object, the present invention includes a plurality of LED elements, a controller for conducting control so that part of the light emitted from the plural LED elements is increased or reduced in intensity, an image display element for forming a desired optical image from the light emitted from part of the LED elements, and a projector for projecting the optical image formed by the image display element: wherein, compared with the first nonuniformity of luminance or color that occurs when light is emitted from the plural LED elements, the second nonuniformity of luminance or color that occurs when part of the light emitted from the LED elements is changed in intensity becomes small in level.

According to the present invention, it is possible to provide a projection-type image display apparatus improved in terms of contrast. It is also possible to provide a projection-type image display apparatus capable of correcting the nonuniformity of luminance or of color.

### BRIEF DESCRIPTION OF THE DRAWINGS

FIG. 1 is a configuration diagram of a projection-type image display apparatus, showing an embodiment of the present invention;

FIGS. 2A and 2B are diagrams each showing changes in luminous beam angle due to adjustment of luminous intensity;

FIG. 3 is a block diagram for controlling the rotating speed of a cooling fan according to a particular adjustment state of luminous intensity;

FIG. 4 is a block diagram for making the color temperature adjustment values and y-values of liquid-crystal panels variable according to a particular adjustment state of luminous intensity;

FIG. 5 is a diagram showing changes in the contrast characteristics of the liquid-crystal panels with respect to a luminous flux incident angle;

FIG. 6 is a diagram showing a mode of the light source according to the present invention;

FIG. 7 is a diagram showing the contrast characteristics of the liquid-crystal display elements with respect to incident beam tilt angles and azimuth angles;

FIGS. 8A and 8B are diagrams relating to an embodiment of a dimmer circuit, FIG. 8A showing a block diagram thereof and FIG. 8B showing a split connection diagram of the LED elements used in the embodiment;

FIG. 9 is a diagram showing a state of incidence of a luminous flux on one of the liquid-crystal display elements used in the embodiment;

FIGS. 10A to 10C are diagrams each showing a different state of change in the shape of a light-emission pattern due to adjustment of luminous intensity;

FIG. 11 is a further diagram showing a state of change in the shape of a light-emission pattern due to adjustment of luminous intensity;

FIG. 12 is a diagram showing the state existing when an arrangement of LED elements is changed into the form matching the view angle characteristics of the display elements;

FIG. 13 is a block diagram showing a second embodiment of a dimmer circuit; and

FIG. 14 is a block diagram showing a third embodiment of a dimmer circuit.

### DETAILED DESCRIPTION OF THE PREFERRED EMBODIMENTS

Embodiments of the present invention are described in detail below using the accompanying drawings. The constituting elements in each drawing that have the same function are each shown with the same reference symbol.

The present invention uses a light source formed up of multiple LED elements, which are each adapted to be adjustable in luminous intensity partially and independently.

### First Embodiment

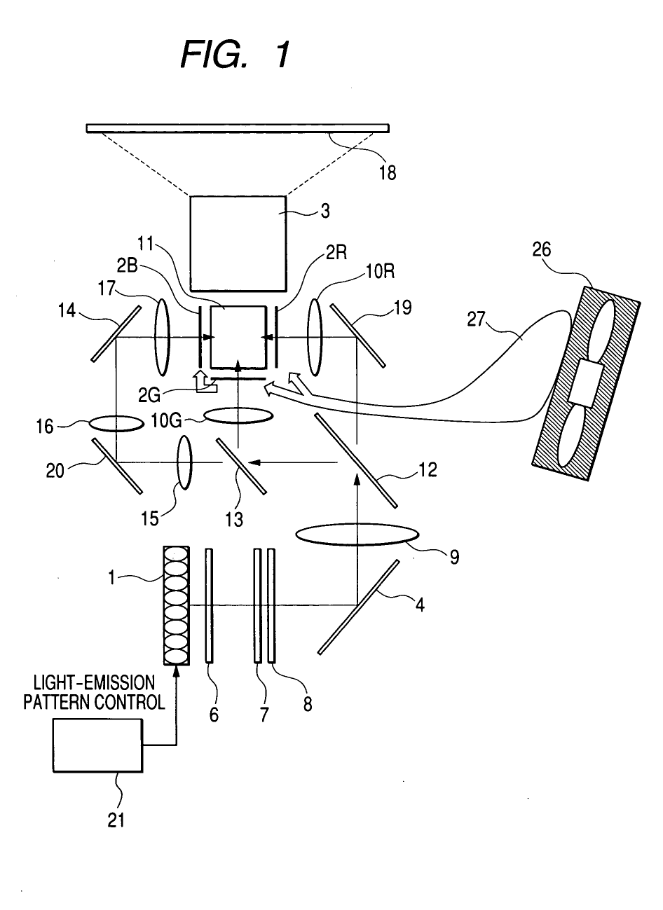

FIG. 1 shows an embodiment of the present invention. In FIG. 1, reference symbol 1 denotes a light source formed up of multiple LED elements. Also, reference symbols 2R, 2G, and 2B denote the transmissive liquid-crystal panels that are image display elements associated with the three primary colors, red (R), green (G), and blue (B), respectively. These liquid-crystal panels, by activating image signal drivers not shown, modulate, in response to image signals, luminous intensity of the beams of light emitted from the light source 1, and thus form optical images. Reference symbol 3 denotes a projection lens, reference symbol 4 a mirror, and reference symbol 6 a first lens array in integrator optics. Reference symbol 7 denotes a second lens array in the integrator optics, reference symbol 8 a polarizing conversion element for aligning in a required polarizing direction the fluxes sent from the second lens array 7, and reference-symbol 9 a focusing lens. Reference symbols 10R and 10G denote condenser lenses, reference symbol 11 a synthesizing prism, and reference symbols 12 and 13 each a dichroic mirror for separating a color. Reference symbol 14 denotes a mirror, reference symbol 15 a first relay lens, reference symbol 16 a second relay lens, reference symbol 17 a third relay lens, reference symbol 18 a screen, and reference symbols 19 and 20 each a mirror. Reference symbol 21 denotes a dimmer circuit that controls turn-on/off of the multiple LEDs constituting the light source 1. Reference symbol 26 denotes a cooling fan, and reference symbol 27 a flow path that forms an air duct for cooling the liquid-crystal panels 2 and other sections.

The flux of light emitted from the light source 1 constituted by the multiple LED elements arranged with a spread in matrix form enters the first lens array 6. The first lens array 6, a matrix-form array of lens cells, splits the incident flux into multiple fluxes and introduces the fluxes so that they pass through the second lens array 7 and the polarizing conversion element 8 efficiently. The lens cells constituting the second lens array 7 formed up of multiple lens cells arrayed in matrix form similarly to the first lens array 6 project shapes of the associated lens cells of the first lens array 6 onto the transmissive liquid-crystal panels 2R, 2G, 2B. At this time, the polarizing conversion element 8 aligns the fluxes sent from the second lens array 7, in the required polarizing direction. Next, the thus-formed projection images of each lens cell of the first lens array 6 are overlapped on the liquid-crystal panels 2R, 2G, 2B, via the focusing lens 9, the condenser lenses 10R, 10G, the first relay lens 15, the second relay lens 16, and the third relay lens 17.

During this process, white light that was emitted from the light source 1 is split into components of the three primary colors, red (R), green (G), and blue (B), by the dichroic mirrors 12, 13, and then the components of the three colors are irradiated onto the liquid-crystal panels 2R, 2G, 2B. The dichroic mirror 12 has red-transmitting, blue-reflecting characteristics, and the dichroic mirror 13 has green-reflecting, blue-transmitting characteristics.

Each of the liquid-crystal panels 2R, 2G, 2B, by activating an image signal driver not shown, conducts luminous intensity modulation for controlling the amount of light passed through the liquid-crystal panel and adjusting contrast in units of pixels, and thus forms an optical image.

The bright optical images irradiated onto the liquid-crystal panels 2R, 2G, 2B, are color-synthesized by the synthesizing prism 11 and then further projected onto the screen 18 through the projection lens 3, whereby a large-screen image can be obtained.

The first relay lens 15, the second relay lens 16, and the third relay lens 17 provide length compensation for optical paths of the liquid-crystal panels 2R, 2G, with respect to an optical path of the liquid-crystal panel 2B.

The condenser lenses 10R, 10G, and the third relay lens 17 suppress a spread of the beams of light after being passed through the liquid-crystal panels 2R, 2G, 2B. Efficient projection via the projection lens 3 is thus realized.

The heat generated when part of illumination light from the light source 1 is absorbed by the liquid-crystal panels 2R, 2G, 2B, and by elements not shown (for example, as an incident-light polarizing plate and an exit-light polarizing plate, both provided in front of and at the rear of the liquid-crystal panels 2R, 2G, 2B), is used for the cooling fan 26 to deliver a stream of air to a cooling duct not shown. The cooling duct forms the flow path 27 to the above polarizing plates and the liquid-crystal panels, whereby cooling is conducted.

During the above image projection, the luminous flux incident angle to each liquid-crystal panel 2 is limited according to particular operating environment of the projection-type image display apparatus by the dimmer circuit 21 described later. The LEDs at the periphery of the light source 1 are turned off by the dimmer circuit 21 to limit the angle of the luminous flux entering each liquid-crystal panel 2.

A shape of the light-emission pattern produced when the LEDs at the periphery of the light source 1 are turned off by the dimmer circuit 21 is predetermined, as described below. FIG. 7 shows an example of contrast characteristics of a general liquid-crystal panel with respect to angles of incidence. Contrast characteristics responsive to a tilt angle of one incident beam with respect to the normal of the liquid-crystal panel surface, and responsive to an azimuth angle of the beam tilt, can be derived from the above figure. This example indicates that contrast of the liquid-crystal display element with respect to the incident angle of the beam is not only determined by the tilt angle of the beam alone, but also depends greatly on the azimuth angle. The above example indicates that for example, if beams having the same tilt angle of 10 degrees are compared, the contrast value obtained differs significantly between incidence at an azimuth angle of 45 degrees from the upper right of FIG. 7 and incidence at an azimuth angle of 135 degrees from a lower right corner on the paper of FIG. 7.

In an actual projection-type image display apparatus, beams of various incident angles enter a liquid-crystal panel in bundles, for which reason, the contrast characteristics of the projection-type image display apparatus appear as overall contrast characteristics of the beams. This means that when beams are intercepted using a stop, an efficient improvement in contrast can be obtained by preferentially intercepting the beams of the tilt angle and azimuth angle which deteriorate contrast. In the present embodiment, however, beams of the tilt angle and azimuth angle that deteriorate contrast are not intercepted using a mechanical stop. Instead, the LED elements constituting the light source 1 are turned off in a state associated with the tilt angle and azimuth angle patterns that deteriorate contrast, whereby control is conducted of a light-emission pattern of the light source 1 constituted by the LED elements.

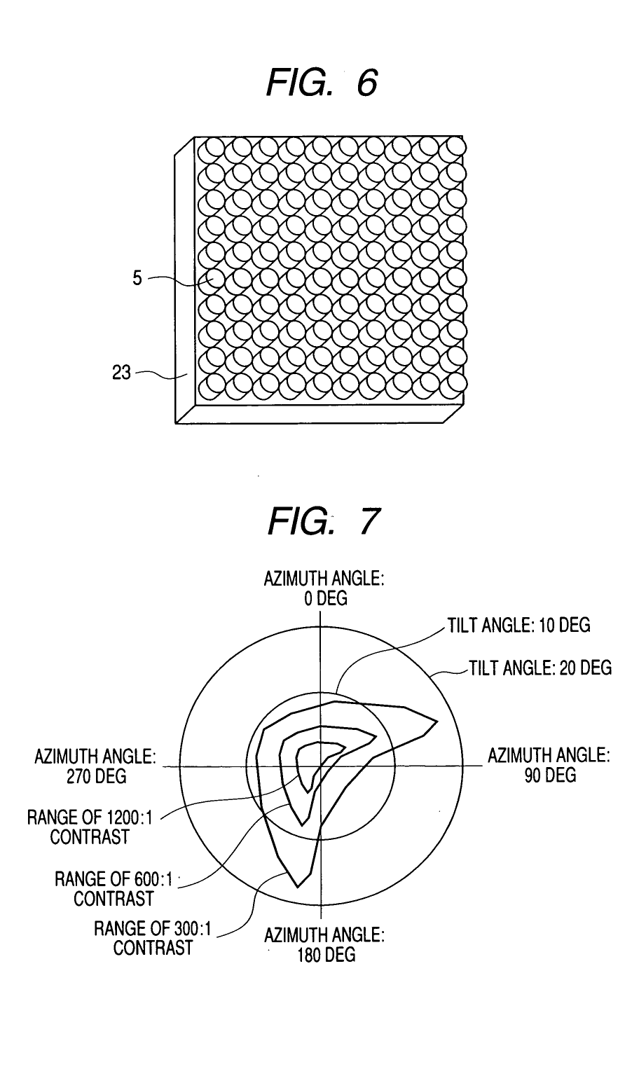

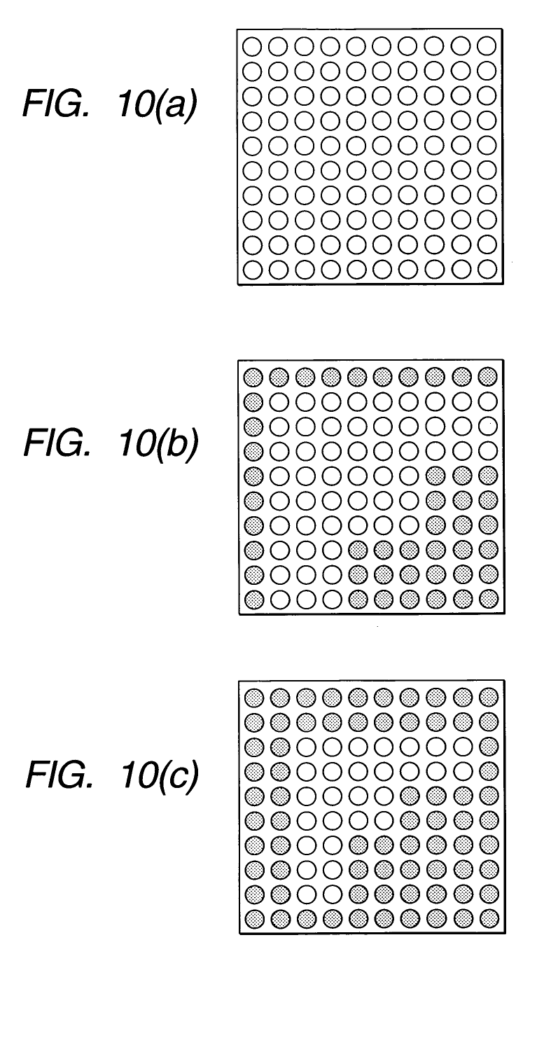

FIG. 6 shows an embodiment of the light source 1. In FIG. 6, LED elements 5 are arranged in matrix form on a substrate 23, and turn-on/off of the LED elements is controlled by the dimmer circuit 21. An example of light-emission pattern control in this case is shown in FIGS. 10A to 10C.

FIGS. 10A to 10C each show a different state in which a shape of a light-emission pattern of the light source 1 is made variable by the dimmer circuit 21. Three-level adjustment described below for the brevity and simplicity of the description. Actually, however, it is possible to give more adjusting levels to allow more precise/delicate adjustment, depending on whether priority is assigned to contrast or brightness during use of the adjusting function. FIG. 10A shows a state in which all LED elements are turned on, and FIG. 10B shows a state in which only the LED elements arranged near the center of the light source 1 are turned on with all other LED elements (arranged at periphery and at a lower right corner on the paper) turned off. FIG. 10C shows another turn-on state only of the LED elements arranged near the center of the light source 1. The states in FIGS. 10B and 10C apply to a liquid-crystal panel having such incident-angle characteristics as shown in FIG. 7, and assumes rotationally asymmetrical patterns. FIG. 9 shows a state of the incident flux from the light source 1 with respect to one of the liquid-crystal panels 2, and the incident state is associated with the state of FIG. 10C which indicates a turn-on state only of the LED elements arranged near the center of the light source 1 in the present embodiment. The incident flux exhibits a rotationally asymmetrical angle distribution associated with incident angle characteristics of the corresponding liquid-crystal panel 2, and represents an efficient improvement in contrast.

For such incident angle characteristics of the liquid-crystal panel 2 as shown in FIG. 7, since contrast significantly decreases at a lower right region on the paper of FIG. 7, it is also effective, in terms of reduction in electric power consumption, to change the arrangement of all LED elements to the pattern matching such incident angle characteristics of the liquid-crystal panel that are shown in FIG. 12.

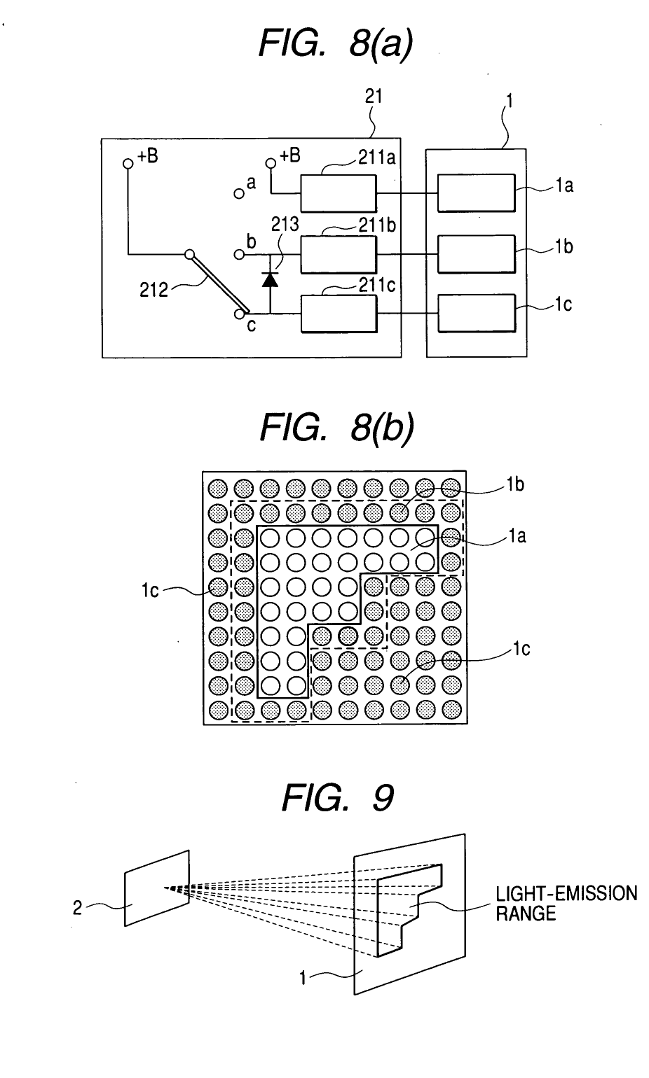

Next, an embodiment of the dimmer circuit for controlling the three-level light-emission patterns shown in FIG. 10 is shown in FIGS. 8A, 8B. FIG. 8B is a split connection diagram of the LED elements for realizing the three-level light-emission patterns, and FIG. 8A is a block diagram of the dimmer circuit. In the present embodiment, as shown in FIG. 8B, the multiple LED elements 5 arranged to constitute the light source 1 are wired in three split regions and adapted to be independently drivable. A region 1a, which is shown internally to a thick solid line in FIG. 8B, is a region of the LED elements 5 that are turned on at all times, and a region 1b, which is shown between the thick solid line and a broken line, and a region 1c shown externally to the broken line, are regions of the intensity-adjustable LED elements 5 that are each turned on or off independently, depending on an operating state of the projection-type image display apparatus.

The dimmer circuit 21 includes, as shown in FIG. 8A, a driver 211 and a selector switch 212. The driver 211 is divided into a driver 211a for driving the LED elements in the region 1a of the light source 1, a driver 211b for driving the LED elements in the region 1b of the light source 1, and a driver 211c for driving the LED elements in the region 1c of the light source 1. The selector switch 212 is a light-emission pattern selector with a common terminal connected to a power supply +B, a terminal “b” connected to an input of the driver 211b, and a terminal “c” connected to an input of the driver 211c. The input of the driver 211b and that of the driver 211c are further connected by a diode 213, a directional element, so as to have the polarities shown.

In the dimmer circuit 21 thus composed, when an all-LED turn-on pattern (associated with a position of the terminal “c”) is selected using the selector switch 212, a signal from the power supply +B is input to the driver 211b via the driver 211c and the diode 213. The LED elements in the regions 1b and 1c of the light source 1 are turned on as a result. Since the +B signal is supplied to the input of the driver 211a at all times, the LED elements in the region 1a of the light source 1 are turned on at all times. Therefore, the light source 1 has all its LED elements activated, the state of which corresponds to FIG. 10A. When the terminal “b” is selected using the selector switch 212, the LED elements in the regions 1a and 1b of the light source 1 are activated, the state of which corresponds to the light-emission pattern shown in FIG. 10B. When a terminal “a” is selected using the selector switch 212, only the LED elements in the region 1a of the light source 1 are activated, which corresponds to the light-emission pattern of FIG. 10C in which only the LED elements located near the center of the light source 1 are activated.

As described above, the dimmer circuit can be used to select either the activation of all LED elements, intended for assigning priority to brightness of the set of LED elements, or the activation only of the LED elements neighboring the center, intended for assigning priority to contrast.

In the present embodiment, a luminous flux quantity of 500 lm and a contrast ratio of 400:1 are obtained under the state where the entire set of LED elements are turned on by the dimmer circuit 21, and a luminous flux quantity of 200 lm and a contrast ratio of 700:1 are realized by activating, via the dimmer circuit 21, only the LED elements arranged in the vicinity of the center of the light source 1.

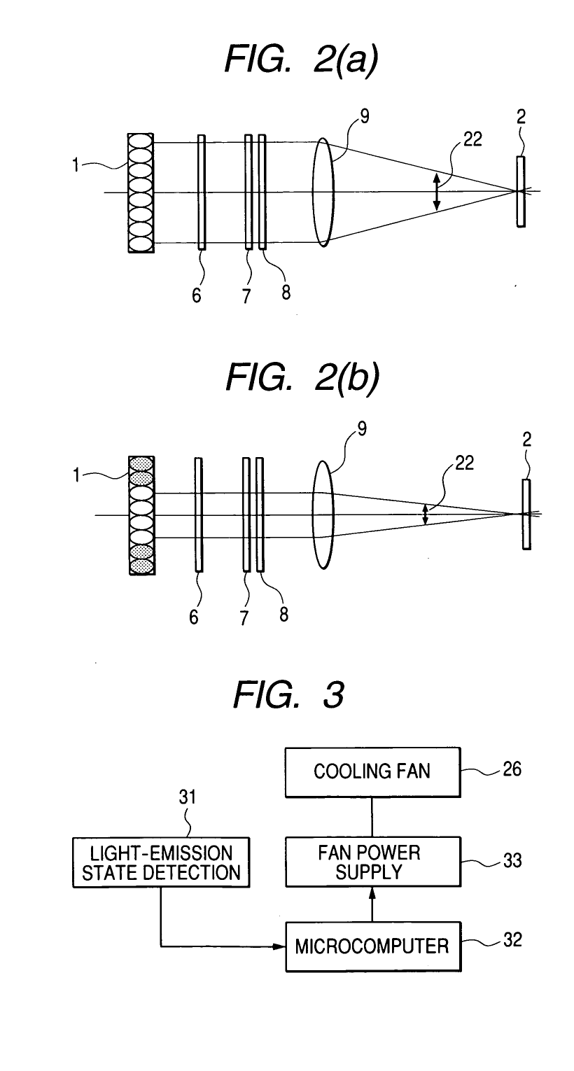

FIGS. 2A and 2B show states in which a luminous flux incident angle 22 to one liquid-crystal panel is made variable by controlling, via the dimmer circuit 21, the light-emission pattern of the light source 1 constituted by the multiple LED elements. An optical path extending from the light source 1 to the liquid-crystal panel 2 is linearly shown without a loopback portion in both FIGS. 2A and 2B. FIG. 2A shows a state in which all LED elements are turned on, with the fluxes from all LED elements being illuminating the liquid-crystal panel. In this case, the projection-type image display apparatus produces the brightest possible state. FIG. 2B shows a state in which only the LED elements neighboring the center of the light source 1 are activated by means of the dimmer circuit 21. Consequently, the luminous flux incident angle 22 to the liquid-crystal panel decreases below the incident angle shown in FIG. 2A. Since part of the set of LED elements is deactivated under a specific state of the dimmer circuit 21, although the image projected decreases correspondingly in brightness, contrast of the projected image can be improved according to the particular decrement in the luminous flux incident angle 22.

In addition, when luminous fluxes are quantitatively reduced by limiting light emission from the peripheral LED elements in the light source via the dimmer circuit 21, the amounts of passage of the fluxes through the liquid-crystal panels 2R, 2G, 2B, and various optics are reduced and increases in temperature are also reduced. Additionally, the amount of heat generated in/from the light source 1 itself is reduced. In response to this, a rotating speed of the cooling fan can be reduced, which, in turn, makes it possible to reduce the raucous noise caused by the rotation of the cooling fan, and hence to improve silence.

FIG. 3 is a block diagram for controlling the rotating speed of the cooling fan according to a particular light-emission state of the light source 1. In FIG. 3, reference numeral 31 denotes a light source light-emission state detector that detects a particular light-emission state of the light source 1 by means of, for example, a signal indicating an operating state of the dimmer circuit 21 (i.e., a light-emission pattern). In the embodiment of FIGS. 8A, 8B, the light source light-emission state detector 31 compares input levels of the drivers 211b and 211c in order to detect position information on the selector switch 212, and can thus detect the operating state of the dimmer circuit 21 (i.e., the light-emission pattern). Reference numeral 32 denotes a microcomputer that serves as an arithmetic and control element for conducting total control of the projection-type image display apparatus, and in response to the detection results sent from the light source light-emission state detector 31, the microcomputer controls a power supply 33 provided for the fan. The power supply 33 for the cooling fan 26 has at least two different supply voltages to be applied thereto, and is adapted to rotate the cooling fan 26 at high speed when the higher of the two voltages is applied, and at low speed when the lower of the two voltages is applied.

For example, if the light source 1 is in its maximum achievable light-emission state in FIG. 3, the light source light-emission state detector 31 outputs to the microcomputer 32 a signal indicating that state, and the microcomputer 32 then provides control so that the fan power supply 33 outputs the higher voltage to rotate the cooling fan 26 at high speed and thus to cool the projection-type image display apparatus strongly. Conversely to the above, if the light source 1 is in the state where only part of the vicinity of its center is emitting light, the cooling fan 26 rotates at low speed, whereby noise coupled with the rotation of the cooling fan 26 can be reduced.

In this way, in the present embodiment, the rotating speed of the cooling fan is automatically varied to suit a particular light-emission state of the light source 1.

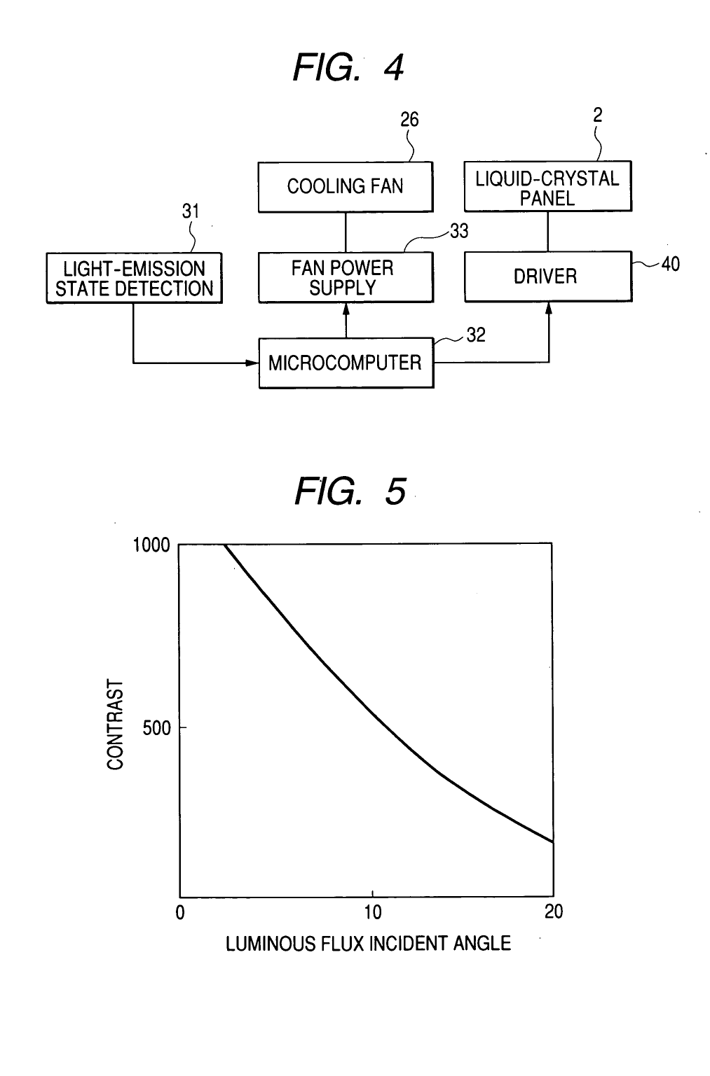

In general, liquid-crystal panels have nonlinear v-t characteristics and are adjusted so as to exhibit required color temperature (white balance) or γ-characteristics, via the liquid-crystal driver that drives the liquid-crystal panel. These electrical characteristics are disclosed in, for instance, Japanese Patent Laid-Open No. Hei 4-270378. As is known, adjustment values for the above electrical characteristics differ according to the quantity of light incident on the liquid-crystal panel and the angle of luminous fluxes incident thereon. The present embodiment is therefore configured so as to automatically vary the adjustment values for the electrical characteristics of the liquid-crystal panels according to the particular light-emission state of the light source 1. FIG. 4 is a block diagram for making the color temperature adjustment values and γ-adjustment values of the liquid-crystal panels according to the particular light-emission state of the light source 1.

In FIG. 4, reference numeral 40 denotes a liquid-crystal panel driver, in which are previously set the appropriate color temperature adjustment values and γ-adjustment values according to the particular light-emission state of the light source 1. The same reference numeral is assigned to the sections having the same function, shown in FIGS. 1, 2A, 2B, and 3, and description of these sections is omitted.

In FIG. 4, in accordance with the detection results sent from the light source light-emission state detector 31, the microcomputer 32 not only controls the cooling fan 26, but also conducts control so that the appropriate color temperature adjustment values, and the γ-adjustment values according to the light-emission state of the light source 1 are set in the liquid-crystal panel driver 40. In response to control from the microcomputer 32, the liquid-crystal panel driver 40 controls the liquid-crystal panels by use of the appropriate color temperature adjustment values and γ-adjustment values matching the light-emission state of the light source 1. For example, under a partially lit state, control is conducted to ensure that the γ-adjustment values are set for reduced green components and that the color temperature adjustment values are also set to be appropriate.

By so doing, the appropriate color temperature adjustment values and γ-adjustment values matching the light-emission state of the light source 1 can be set and this, in turn, makes it possible to provide the projection-type image display apparatus optimal for an operating environment, whether it be a bright or dark operating environment or the like.

While the present embodiment has been described taking an example of using transmissive liquid-crystal panels as image display elements, it goes without saying that only if reflective liquid-crystal panels or other image display elements capable of projecting images whose contrast depends on the luminous flux incident angle are used instead, can the advantageous effects of the invention be obtained without limitations. In addition, optics typically has the property that smaller passage angles of beams result in less stray light being caused by random reflection or the like, and thus in a contrast ratio correspondingly improving. The embodiment effects of the present invention can therefore be obtained, irrespective of the kind of image display element used.

Furthermore, although an example of deactivating or activating LED elements has been described above, the LED elements can, of course, also be such that a particular section thereof is reduced in light-emission intensity, instead of being deactivated, or that other sections are increased in light-emission intensity.

As described above, according to the present embodiment, it is possible to provide a projection-type image display apparatus which can control, without using a mechanical stop, a light-emission pattern of a light source formed up of multiple LED elements, in response to the “incident-angle characteristics of contrast” that differ in contrast performance according to the characteristic direction-of-incidence of image display elements such as liquid-crystal panels. In addition, since a lens thick-walled in an optical-axis direction and having a diameter almost equal to that of the aperture in a reflector is not necessary, it is possible, without causing structural complexity of the projection-type image display apparatus or increasing its dimensions or its price, to lessen decreases in brightness while at the same time improving contrast, and to use a state of brightness and that of contrast effectively according to a particular mode of operation.

Next, reduction in the nonuniformity of luminance and color of the projection-type image display apparatus of the present invention is described below. In general, the nonuniformity of luminance is caused by not only angular biases of the fluxes of light emitted from the light source, but also the nonuniformity of quality of the optics which transmits the fluxes, and occurs for each single color produced by the dichroic mirrors used for color splitting or synthesizing, or by a synthesizing prism. In terms of the nonuniformity of luminance, the color of various colors that is introduced through a relay lens (in the present embodiment, blue) overlaps two other colors on the projection screen after left/right reversal. The nonuniformity of color occurs as a result. The present invention is characterized in that the nonuniformity of luminance and that of color can be corrected in a light-emission state of the light source 1.

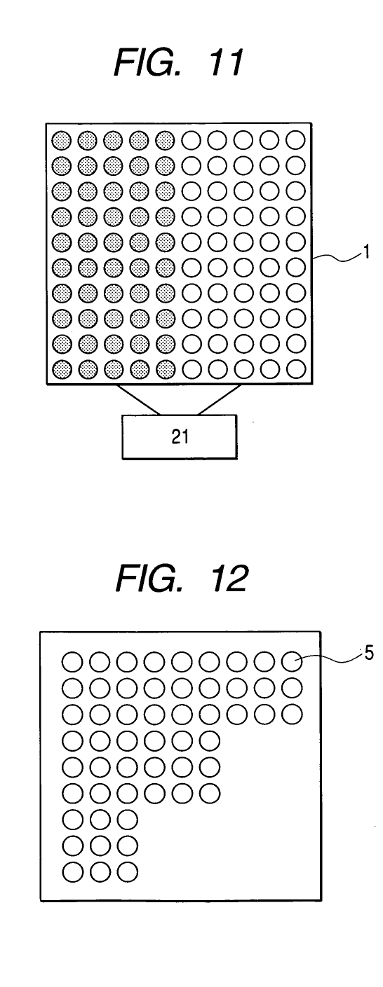

For example, if such nonuniformity of color is occurring that causes a difference in color temperature between the left and right of the projection screen, the nonuniformity of luminance of each color is causing the above nonuniformity of color. In this case, therefore, the nonuniformity of luminance is removable by adjusting the left/right balance of the fluxes emitted from the light source 1, and consequently, the nonuniformity of color is reducible. FIG. 11 shows only the light source 1 and dimmer circuit 21 of the projection-type image display apparatus according to the present invention. Although only the right half of the light source 1 is activated in the figure, the dimmer circuit 21 can not only adjust the luminous intensity of the peripheral and near-central sections of the light source 1 independently as described above, but also adjust luminous intensity of the left half and right half of the light source 1 independently. In this case, adjusting luminous intensity is accomplished by making the intensity of the light source 1 variable. It is possible, by adjusting the left half and right half of the light source 1 in brightness independently according to a particular state of color nonuniformity on the projection screen, to correct the nonuniformity of R, G, B each in luminance and consequently to reduce the nonuniformity of color on the projection screen.

In the present invention, since the dimmer circuit 21 thus makes the light-emission state (light-emission pattern) of the light source variable (in the above example, adjusts the brightness of the left and that of the right) in response to a nonuniformity level of luminance, it is possible to reduce the nonuniformity of luminance and the nonuniformity of color, associated therewith, without, unlike the conventional technology earlier described herein, sacrificing grayscale characteristics of the image display elements.

While the above example applies to horizontal splitting for adjustment, the present invention is not limited to/by this example and it goes without saying that splitting in a diagonal direction or a vertical direction in response to a nonuniformity level of luminance may also be possible. More complex nonuniformity of luminance and more complex nonuniformity of color can be corrected by allowing independent adjustment in a diagonally or vertically split state as well. In addition, there is no need to provide control in a two-split state, and depending on a particular nonuniformity level of luminance or color, the light source 1 may be splittable into more than two sections prior to correction. Of course, equal splitting is not necessary. Alternatively, only specific sections may be split into a spot-like form for correction. In either case, appropriate corrections are conducted according to a particular nonuniformity level of luminance or color.

As set forth above, according to the present embodiment, since the light source includes multiple light-emitting elements, it becomes possible to adjust brightness partially and thus to provide a projection-type image display apparatus capable of correcting the nonuniformity of luminance and color appropriately.

### Second Embodiment

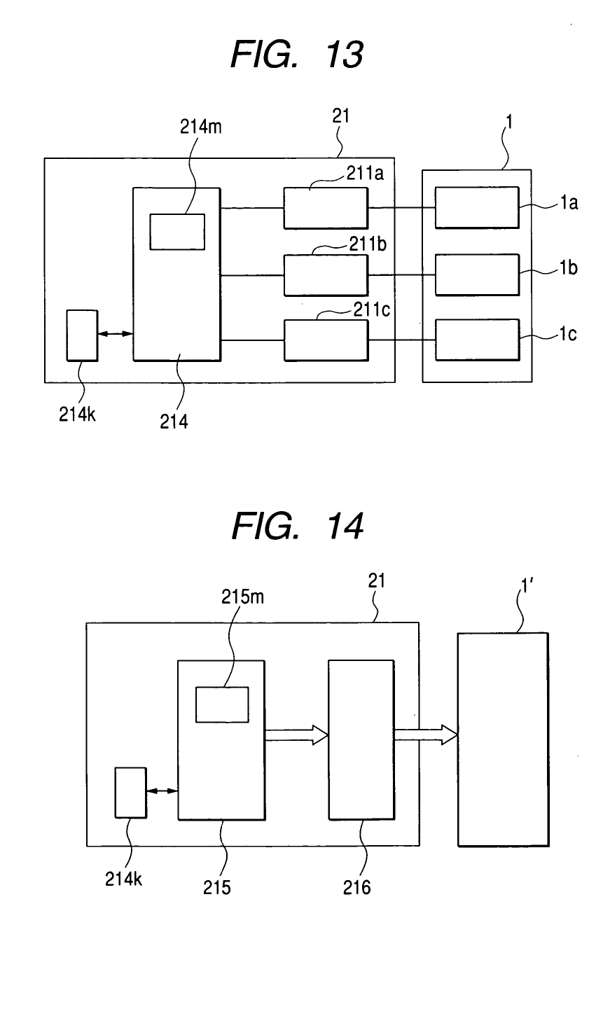

The above-described embodiment uses a mechanical selector switch to control the dimmer circuit. Next, a second embodiment, which uses electrical control, is shown in FIG. 13. In this figure, the same sections as those of FIG. 8 are each shown with the same reference numeral. In FIG. 13, a microcomputer is used instead of a mechanical selector switch.

In FIG. 13, after receiving, from an operations key 214k, an instruction for selecting either of such light-emission patterns of a light source 1 as shown in FIGS. 10A to 10C, microcomputer 214 can output a driving signal to drivers 211 (211a, 211b, 211c) on the basis of such light-emission region information as shown in FIG. 8B, the information being previously stored in a built-in memory 214m, and thus select a light-emission state of the light source 1.

When a configuration based on microcomputer control is adopted as in the present embodiment, providing the microcomputer 32 of FIGS. 3 and 4 with the above function simplifies circuits and makes a light source light-emission state detector 31 unnecessary.

### Third Embodiment

An embodiment of a dimmer circuit is shown as a third embodiment in FIG. 14.

In FIG. 14, a light source 1′, unlike the light source 1 of FIG. 8B, is not wired in multiple split light-emission regions and is adapted so that all its LED elements can be independently driven. A driver 216 drives each LED element of the light source 1′ independently. For example, each LED element 5 of the light source 1′ is independently connected to the driver 216, which drives each LED so as to allow control of its turn-on/off and brightness. Such “incident-angle characteristics of contrast” as shown in FIG. 7, for example, are previously stored in the built-in memory 215m of the microcomputer 216, which, after receiving from the operations key 214k an instruction for selecting a light-emission pattern of the light source 1′, conducts on/off control of each LED element 5 of the light source 1′, based on the “incident-angle characteristics of contrast” within the memory 215m.

Constructing the light source 1′ in this way makes more precise/delicate control possible. Of course, since each LED can also be adjusted in terms of brightness (luminance), it becomes possible to correct the nonuniformity of luminance and that of color, associated therewith.

For the above reasons, it is possible to provide a projection-type image display apparatus having a light source constituted by a plurality of light-emitting elements arranged with a spread, and allowing a state of brightness and that of contrast to be used effectively according to a particular mode of operation, without causing structural complexity of the projection-type image display apparatus or increasing its dimensions or its price, by appropriately adjusting the arrangement of the light-emitting elements and a light-emission state. Additionally, high-quality image projection that allows the nonuniformity of luminance and that of color to be corrected can be realized by providing a light source constituted by a plurality of light-emitting elements, and independently adjusting each section of the light source in brightness.

1. A projection-type image display apparatus, comprising:
a plurality of LED elements positioned in a plane surface;
a controller which controls a shape of a light-emission pattern of said plural LED elements;
an image display element which forms a desired optical image from the light emitted from at least a part of said plural LED elements; and
a projection unit which projects the optical image formed by said image display element;
wherein, said shape of said light-emission pattern of said plural LED elements is changed into a form matching a view angle characteristics of said image display element.

2. (canceled)

3. The projection-type image display apparatus according to claim 1, wherein:
said controller selects a first mode for activating said plural LED elements to emit light, or a second mode for activating the LED elements to a prescribed number forming said shape of a light-emission pattern matching said view angle characteristic of said plural LED elements to emit light.

4. (canceled)

5. The projection-type image display apparatus according to claim 3, wherein:
a first contrast obtained by emitting light of said plural LED elements in said first mode in comparison with a second contrast obtained by emitting light of said LED elements to the prescribed number of said plural LED elements in said second mode is such that, said second contrast is higher than said first contrast.

6. (canceled)

7. (canceled)

8. (canceled)

9. The projection-type image display apparatus according to claim 3, wherein:
said plurality of LED elements include first LED elements arranged in a center thereof, and second LED elements arranged at peripheral sections of said first LED elements, and said controller controls so that it turns on said first LED elements without turning on said second LED elements, and said shape of a light-emission pattern matching said view angle characteristics of said plural LED elements is formed.

10. (canceled)

11. (canceled)

12. (canceled)

13. (canceled)

14. (canceled)

15. (canceled)

16. (canceled)

17. (canceled)

18. The projection-type image display apparatus according to claim 1, wherein said plurality of LED elements include first LED elements arranged in the center thereof, and second LED elements arranged at peripheral sections of said first LED elements, a said controller controls to increase light-emission intensity of said first LED elements to be higher than a light0-emission intensity of said second LED elements, and said controller controls so that said shape of a light-emission pattern matching said view angle characteristics of said plural LED elements is formed.

19. The projection-type image display apparatus according to claims 18, wherein:
said controller selects a first mode in which both of said first LED elements and said second LED elements are emitted in a first light-emission intensity, or a second mode in which said first LED elements are emitted in said first light-emission intensity and said second LED elements are emitted in a second light-emission intensity which is lower than said first light-emission intensity, and controls so that in a first contrast obtained in said first mode in comparison with a second contrast obtained in said second mode, said second contrast is higher than said first contrast.

20. (canceled)

21. The projection-type image display apparatus according to claim 3, further comprising a cooling fan, wherein said controller controls so that a rotating speed of said cooling fan in said first mode is higher than a rotating speed of said cooling fan in said second mode.

22. The projection-type image display apparatus according to claim 19, further comprising a cooling fan, wherein said controller controls so that a rotating speed of said cooling fan in said first mode is higher than a rotating speed of said cooling fan in said second mode.
